(19) United States
(12) Patent Application Publication
(10) Pub. No.: US 2012/0085320 A1
(43) Pub. Date: Apr. 12, 2012

(54) High Volume Combustion Catalyst Delivery System

(75) Inventors: Gary C. Lawson, Orem, UT (US); William M. Hardy, Crosby, TX (US); David Petryk, Houston, TX (US); Christopher Petitta, Chandler, AZ (US)

(73) Assignee: EMISSIONS TECHNOLOGY, INC., Houston, TX (US)

(21) Appl. No.: 13/269,010

(22) Filed: Oct. 7, 2011

Related U.S. Application Data
(60) Provisional application No. 61/391,370, filed on Oct. 8, 2010.

(51) Int. Cl. F02M 25/00

(52) U.S. Cl. 123/434

(57) ABSTRACT

A high volume combustion catalyst system of the current invention delivers an aerosol liquid catalyst into a diesel engine for the express purpose of enhancing combustion efficiency, thus, lowering fuel consumption and emissions. This invention is capable of extremely precise catalyst delivery and can service the full range of commercially available diesel engines.

### FIELD OF THE INVENTION

The present invention relates generally to a system for delivering a catalyst to an air intake stream of a diesel engine. More specifically, the invention includes a modular system comprising a feed section, a distribution section, an injection section, and a control section that transport a catalyst from a fuel tank in the feed section through the distribution section and into the injection section where the catalyst is atomized and sprayed as an aerosol into the air intake stream of the diesel engine. The control section monitors and adjusts the amount of catalyst being input into the engine based on input parameters. The atomized catalyst creates a more efficient combustion process and allows the diesel engine to run with less fuel and emissions.

### BACKGROUND OF THE INVENTION

Catalysts are used in combustion reactions to increase the efficiency and energy outputs of all types of engines. In conventional catalyst delivery systems, the catalyst is generally delivered to the region of the engine where the combustion reaction occurs.

In one prior art catalyst delivery system designed for use in diesel engines, the catalyst is provided in an 800 ml bottle. The catalyst is activated to produce bubbles such that the bubbles capture the working elements of the catalyst. When the bubbles burst, the elements are released in the head space of the bottle and are then pulled in to the engine's air stream prior to the turbo (or the device that increases the amount of air going into diesel engine) through a feed line and attached fitting. The amount of catalyst that feeds the engine is determined by the velocity of the air stream that is produced by the turbo rate.

This prior art catalyst delivery system is limited in that it can only handle a limited size of diesel engines because the amount of catalyst delivered cannot be changed. Because of the nature of the catalyst delivery system, it is possible that multiple delivery systems would be required on one engine. Additionally, the prior art catalyst delivery system has fixed input parameters that cannot be changed once it is placed on the diesel engine.

Moreover, the position of the prior art catalyst delivery system in the diesel engine has to be in front of the turbo portion of the engine in order to properly deliver the catalyst to the engine. This placement is required because the prior art catalyst delivery system has to use the turbo portion of the engine to pull the catalyst into the engine's air stream using the vacuum of the turbo.

This differs from the disclosed catalyst delivery system. In particular, the new catalyst delivery system can handle various engine sizes because the amount and rate of catalyst delivered can be controlled using a microprocessor or other input system. This allows various amounts of catalyst to be dispensed in the engine based on the size and power of a particular engine.

Additionally, the position of the disclosed catalyst delivery system in the diesel engine can be varied. The new catalyst delivery system does not depend on the vacuum of the turbo portion of the engine to pull the catalyst into the engine's air stream. As such, the catalyst delivery system of the new invention can be placed before or after the turbo of the diesel engine. Because the nozzle of the injector in the new invention atomizes the catalyst, it can be injected directly into the air stream or the cylinders of the engine with or without the aid of the turbo.

### SUMMARY OF THE INVENTION

The present invention is directed to a modular high volume combustion catalyst delivery system that delivers an atomized, aerosol catalyst to the air intake stream of a diesel engine.

A high volume combustion catalyst delivery system for use in diesel engines comprises a feed section that includes a pump, a feed tank, and a feed section outlet; a distribution section that includes a distribution section inlet coupled to the feed section outlet, at least one distribution section outlet, and at least one valve; and an injection section with at least one injector with an inlet coupled to the distribution section outlet. A liquid catalyst is stored in the feed tank and pumped through the feed section outlet and into the distribution section inlet. The liquid catalyst is pressurized as it moves through the pump in the feed section of the system. The liquid catalyst then moves through the at least one valve in the distribution section and through the at least one distribution section outlet and into the inlet of the at least one injector. When the pressurized liquid catalyst enters the inlet of the injector, it is atomized into an aerosol spray. The atomized catalyst spray is then injected by the injector into the diesel engine.

It is an object of the present invention to provide a high volume combustion catalyst delivery system that delivers a catalyst in aerosol form to the air intake stream of a diesel engine.

It is a further object of the present invention to provide a high volume combustion catalyst delivery system that is modular where each piece is interchangeable within the diesel engine.

It is a further object of the present invention to provide a high volume combustion catalyst delivery system with a programmable microprocessor to monitor the diesel engine instrumentations.

It is a further object of the present invention to provide a high volume combustion catalyst delivery system that is capable of precise catalyst delivery into the air stream of the diesel engine based on parameters input into the programmable microprocessor.

It is a further object of the present invention to provide a high volume combustion catalyst delivery system that can service a full size range of commercially available diesel engines.

The novel features that are considered characteristic of the invention are set forth with particularity in the appended claims. The invention itself, however, both as to its structure and its operation together with the additional object and advantages thereof will best be understood from the following description of the preferred embodiment of the high volume combustion catalyst delivery system when read in conjunction with the accompanying drawings. Unless specifically noted, it is intended that the words and phrases in the specification and claims be given the ordinary and accustomed meaning to those of ordinary skill in the applicable art or arts. If any other meaning is intended, the specification will specifically state that a special meaning is being applied to a word or phrase. Likewise, the use of the words “function” or “means” in the Description of Preferred Embodiments is not intended to indicate a desire to invoke the special provision of 35 U.S.C. §112, paragraph 6 to define the invention. To the contrary, if the provisions of 35 U.S.C. §112, paragraph 6 are sought to be invoked to define the invention(s), the claims will specifically state the phrases “means for” or “step for” and a function, without also reciting in such phrases any structure, material, or act in support of the function.

Moreover, even if the provisions of 35 U.S.C. §112, paragraph 6 are invoked to define the inventions, it is intended that the inventions not be limited only to the specific structure, material or acts that are described in the preferred embodiments, but in addition, include any and all structures, materials or acts that perform the claimed function, along with any and all known or later developed equivalent structures, materials, or acts for performing the claimed function.

### BRIEF DESCRIPTION OF THE DRAWINGS

FIG. 1 shows the preferred embodiment of the feed section of the invention.

FIG. 2 shows the preferred embodiment of the distribution section of the invention.

FIG. 3 shows a cross section of a piezoelectric injector used in an embodiment of the invention.

FIG. 4 shows a view of the preferred embodiment of the present invention with the modular sections connected.

FIG. 5 shows mounting locations of the injectors on the diesel engine.

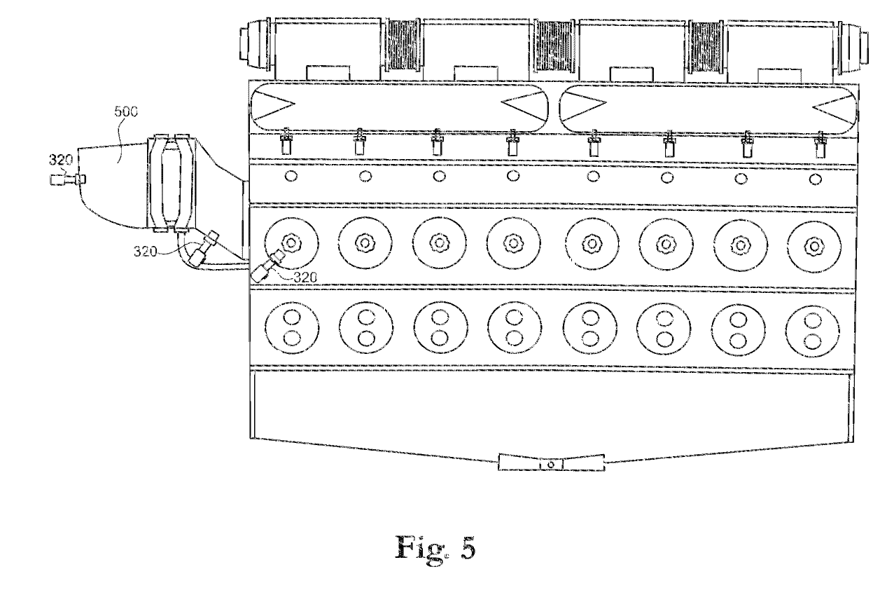

FIG. 6 shows a cross section of a pneumatic injector used in an embodiment of the invention.

FIG. 7 shows a flow diagram of the present invention.

### DESCRIPTION OF PREFERRED EMBODIMENTS

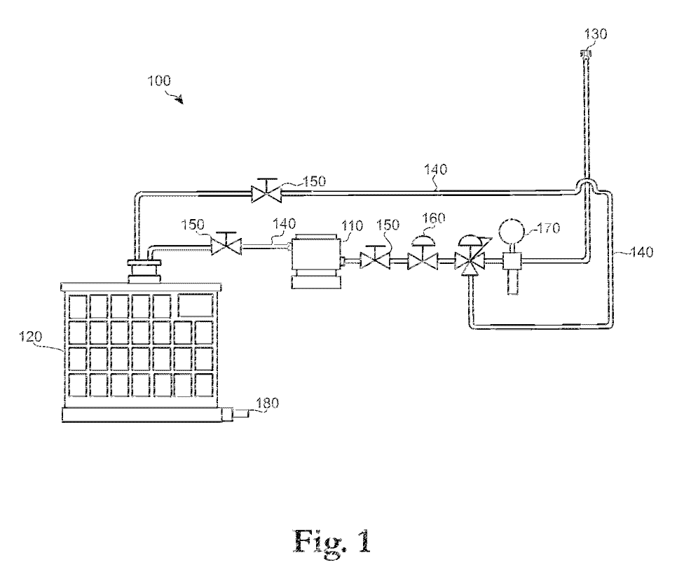

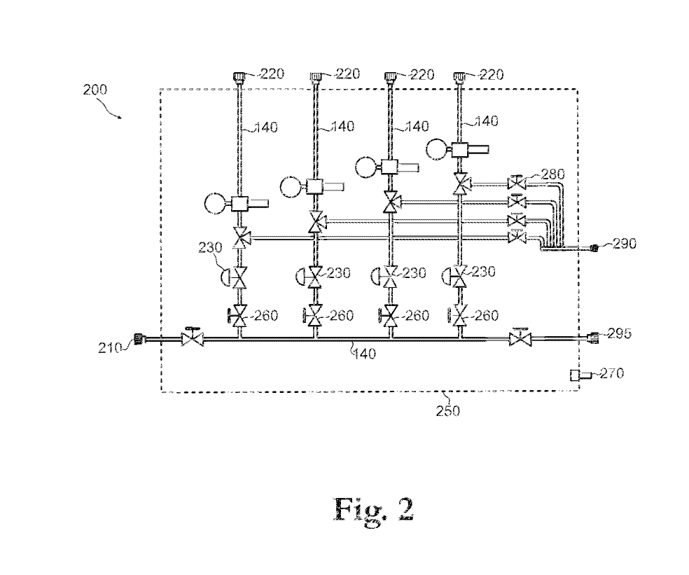

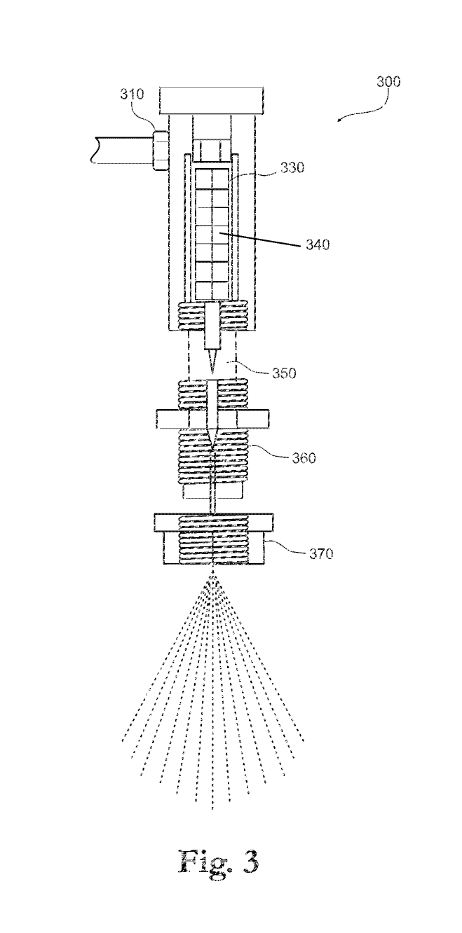

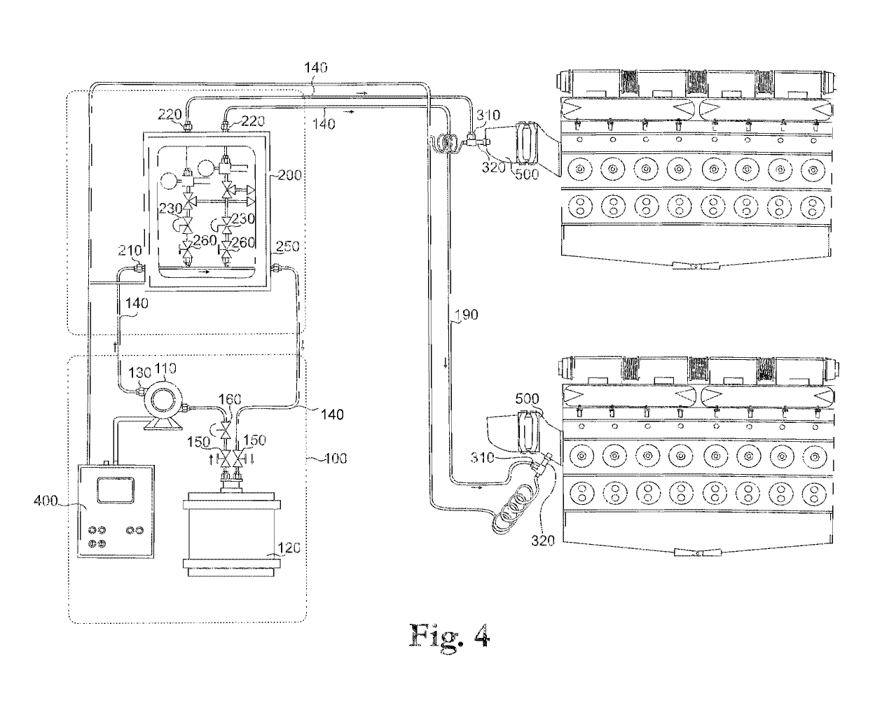

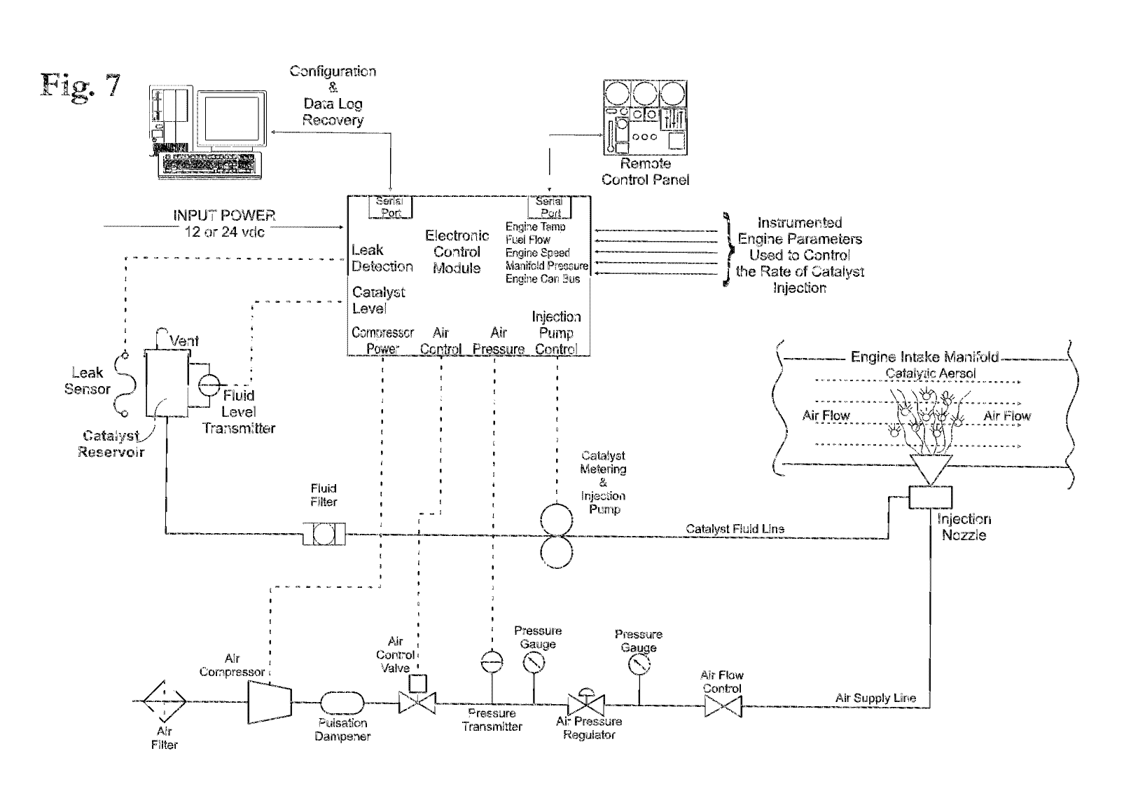

The high volume combustion catalyst system of the current invention is designed to deliver an aerosol liquid catalyst into the air stream of a diesel engine. The invention is intended for use with large diesel engines ranging in size from 500 bhp to 120,000 bhp. In the preferred embodiment of the current invention, there are four (4) modular sections that comprise the high volume combustion catalyst system. Specifically, the preferred embodiment of the invention includes a feed section 100 shown in FIG. 1, a distribution section 200 shown in FIG. 2, an injection section 300 shown in FIG. 3, and a control section 400 shown in FIG. 4. These modular sections are shown coupled together in FIG. 4. FIG. 7 shows a flow diagram of the current invention. The modular nature of the high volume combustion catalyst delivery system is preferred because this arrangement provides a volume controlled system. In particular, each phase of the modular system is controlled separately such that the end result is a precisely delivered amount of catalyst to the engine for maximum efficiency and results. This volume controlled system can be adjusted such that a consistent aerosol spray containing the catalyst is injected into the air stream of the engine. Moreover, the modular nature of the high volume combustion catalyst delivery system provides control over the amount of catalyst injected into the system as well as the size of the aerosol droplets carrying the catalyst.

As shown in FIGS. 1 and 4, the feed section 100 of the invention includes a pump 110, a feed tank 120, and a feed section outlet 130. The pump 110 pumps the liquid catalyst from the feed tank 120 through the tubing 140 and to the feed section outlet 130. When the liquid catalyst moves through the pump 110, the liquid catalyst is pressurized. The pressurized liquid catalyst then moves through the tubing 140 in the feed section 100 and into the feed section outlet 130. The feed section outlet 130 is coupled to the distribution section 200 via the distribution section inlet 210. The pressurized liquid catalyst flows into the distribution section via this connection.

In the preferred embodiment, the feed section 100 also includes at least one manual shut off valve 150. The manual shut off valve 150 allows a user to stop the flow of the liquid catalyst through the feed section 100. This may be necessary when maintenance is being performed on the feed section 100 or the feed section 100 is being removed for replacement or other reasons. In addition to the manual shut off valve 150, a control valve 160 is included in the feed section 100. The control valve 160 controls the amount of liquid catalyst going to the pump and allows the flow level of the liquid catalyst to be manipulated based on the size of the engine receiving the catalyst. This control valve 160 can be manipulated manually, or it can be automatically adjusted via the control section 400 of the invention based on pre-set conditions or parameters.

In the preferred embodiment of the invention, the feed section 100 also includes an operating pressure control regulator 170. The operating pressure control regulator 170 ensures that the pressure in the feed section 100 of the system is operating at optimal conditions. If the operating pressure in the system exceeds a pre-set threshold, the valve on the pressure regulator 170 will open allowing the system to exhaust to the outside environment. This is a safety mechanism to prevent damage to the catalyst delivery system and the diesel engine. Additionally, the pressure regulator 170 controls the amount of catalyst that is dispensed through the nozzle 325 or 925 of the injector 320 or 900 to produce a uniform aerosol pattern and droplet size. These parameters ensure that the pressurized liquid catalyst properly mixes with the engine air stream to provide maximized combustion results.

Further, the feed section 100 includes a leak detector 180 on the feed tank 120 that is activated when liquid catalyst is leaking from the feed tank 120. This ensures that liquid catalyst is not wasted or damaging other engine parts. Moreover, the leak detector 180 ensures that there is no loss of volume of liquid catalyst in the system. Because the catalyst delivery system is programmed to run for a specified time period before a scheduled refill of liquid catalyst by the user, it is important that the catalyst delivery system maintain the proper amount of liquid catalyst for optimal operating conditions. If a leak is detected, a signal is sent to the controller and the system user is alerted.

Also included in the feed section 100 is a recycle stream 190. The recycle stream 190 carries excess liquid catalyst back to the feed tank 120. In the process of delivering the catalyst to the injectors 320 or 900, the manifold 250 of the distribution section 200 is flooded to ensure that each injector 320 or 900 has enough catalyst to inject into the engine. The amount of catalyst that is not used by the injector 320 or 900 is returned to the feed tank 120 via the recycle stream 190. This ensures that no liquid catalyst is wasted in the process. Moreover, the recycle stream 190 receives liquid catalyst product that is not consumed in the distribution section 200 so that the distribution section 200 maintains a proper level of liquid catalyst product to maintain optimum performance of the injectors 320 or 900.

The distribution section 200 of the invention includes at least one distribution section outlet 220 and at least one valve 230 in addition to the distribution section inlet 210. The distribution section 200 of the invention allows the liquid catalyst to be evenly delivered to the injection section 300. A manifold box 250 houses the components of the distribution section 200 of the invention. The pressurized liquid catalyst passes through the tubing 140 and the valves 230 in the distribution section 200. The valves 230 are manually pre-set to a specified pressure level.

The pre-set pressure level ensures a constant pressure at the injector 320 for optimal atomization of the liquid catalyst. The pressurized liquid catalyst is then evenly distributed through the distribution section outlets 220 to the injector inlets 310 as seen in FIG. 4. The programmable microprocessor in the control section 400 of the invention controls the rate at which the liquid catalyst is distributed to the distribution section outlets 220. The number of distribution section outlets 220, and in turn injectors 320 or 900, depends on the size and type of diesel engine in addition to the efficiency and running conditions desired.

In the preferred embodiment of the invention, the distribution section 200 also includes at least one manual shut off valve 260. The manual shut off valve 260 allows a user to stop the flow of the liquid catalyst through the distribution section 200. This may be necessary when maintenance is being performed on the distribution section 200 or the distribution section 200 is being removed for replacement or other reasons such as holding liquid catalyst or pressure in the tubing 140.

It is preferred that the distribution section 200 also includes a relief valve 280 and a pressure relief and system drain 290. The relief valve 280 can be activated if the distribution section 200 has exceeded a pre-set operating pressure. The pressure relief and system drain 290 are opened to allow the system to exhaust to the outside environment. This is a safety mechanism to prevent damage to the catalyst delivery system and the diesel engine. These systems are also required for maintenance so that the tubing can be isolated to relieve pressure and catalyst product.

The distribution section 200 also includes a leak detector 270 and a recycle stream 295. As in the feed section 100, the leak detector 270 in the distribution section 200 is activated when liquid catalyst is leaking from the distribution section 200. This prevents liquid catalyst from being wasted or damaging other engine parts. If a leak is detected, a signal is sent to the controller and the system user is alerted. The recycle stream 295 carries excess liquid catalyst back to the feed section 100 and ultimately the feed tank 120. This ensures that no liquid catalyst is wasted in the process. Additionally, the leak detector 270 and recycle stream 295 can provide an indication of pressure changes in one or more of the feed lines for quality control of the system.

Once in the injectors 320 or 900, the pressurized liquid catalyst is atomized into an aerosol spray. The liquid catalyst is atomized by being forced through the injector nozzle 325 or 925. In the preferred embodiment, the injector nozzle 325 or 925 has holes between 5 and 10 microns. The atomized catalyst spray is injected directly into the air intake stream 500 leading to the combustion chambers of the diesel engine. It is preferred to inject the atomized catalyst spray directly into the air intake stream 500 of the engine because at this location the atomized catalyst spray is thoroughly mixed with the air and provides more efficient combustion in the engine.

In the preferred embodiment of the invention, the invention utilizes pneumatic injectors 900. The pneumatic injectors 900 are preferred because they precisely control the amount of catalyst injected into the diesel engine. In an alternate embodiment, it is also possible to use piezoelectric injectors 320 in the invention.

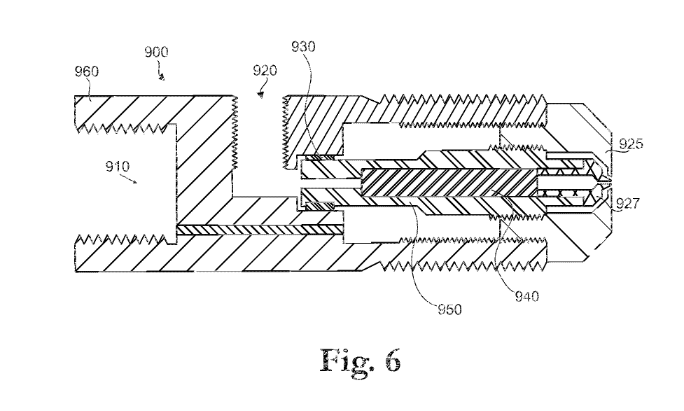

The preferred embodiment of the pneumatic injector 900 is shown in the cross section view of FIG. 6. The pneumatic injector 900 includes an air inlet port 910, a fluid inlet port 920, a TEFLON® seal 930, an integration material 940, and a fluid integration chamber 950. The integration material 940 improves the atomization of the fluid catalyst at low flow rates.

The injector nozzle 925 from which the atomized catalytic liquid and air is ejected in aerosol form has a fluid inlet port 920 and an air inlet port 910 which are attached to the body portion 960 of the injector 900. The pneumatic injector nozzle 925 is capable of mixing one or more catalytic liquids with air and discharges the atomized liquid through an orifice 927 as small liquid particles of uniform size. As the fluid flows through the turbulent inlet and outlet interfaces of air passing through the nozzle orifice 927 the liquid is pulverized into small droplets of finely divided sizes ranging between 0.5 and 1.5 microns in diameter and are evenly distributed into the air intake stream 500 of the diesel engine. A fluid integrating chamber 950 is contained within the body portion 960 of the injector 900. The fluid integration chamber 950 is filled with an integration material 940 and has fluid communication between the fluid inlet port 920 and discharge orifice 927. The fluid integration chamber 950 works to evenly distribute the delivery rate of catalyst to the atomizing region of the nozzle 925. Air is delivered through the air inlet port 910 to the nozzle 925 through a control valve (not shown) which is electrically activated by the Monitoring and Control System (MCS). Fluid is delivered through the fluid inlet port 920 to the nozzle 925 through a metering pump (not shown) which is electrically activated by the MCS.

In an alternate embodiment of the invention, the invention utilizes a piezoelectric injector 320. The preferred embodiment of the piezoelectric injector 320 is shown in the cross section view of FIG. 3. The piezoelectric injector 320 includes the piezoelectric stack 330, the catalyst fluid path 340, the injector plunger 350, the modular injector nozzle 360, and the mounting bung 370. The piezoelectric injector is activated by 24 VDC or 110 VAC power which sends a square wave pulse that goes to MCS to control an actuator on the injector plunger 350. When the pressurized liquid catalyst enters the injector 320, it travels through the catalyst fluid path 340 and is atomized into an aerosol spray. The plunger 350 is a needle plunger that moves up and down and works like a valve. The plunger 350 moves the fluid through the openings in the injector 320 to create the aerosol. The aerosol spray is then injected into the air stream of the diesel engine.

FIG. 4 shows a representative view of the placement of the injectors 320 or 900 on the diesel engine. The mounting locations and the vertical placement of the injectors 320 or 900 are variable. The injectors 320 or 900 are placed on the air intake stream of the diesel engine where they can be most efficiently utilized. This placement is determined based on access to the combustion chamber and air stream. The number of injectors is determined based on the size of the engine and the amount of catalyst required for the most efficient running of the engine.

Aerosol spray is the form preferred for delivery of the catalyst to the air stream of the diesel engine because the aerosol droplets are small enough to thoroughly mix with the engine's air stream system. Proper mixing of the catalyst is better achieved with the small aerosol droplet size. Thorough mixing allows for efficient use of the catalyst to maximize the combustion results in the engine. The droplets are preferably less than 50 microns. The size of the droplets coming out of the injector nozzles 325 or 925 can be changed depending on the type and size of engine. This is achieved by inputting specific parameters into the control section of the system.

The preferred embodiment of the invention also includes a control section 400. The control section 400 manages the feed, distribution, and injection sections 100, 200, and 300 to assure that a controlled amount of catalyst is delivered into the diesel engine utilizing injection frequency and duration pulse control. The injector frequency is the number of times the injector injects the catalyst product into the engine air stream system in a set time. The injector frequency varies based on the size and type of engine. This injector frequency is controlled by the MCS. The duration pulse is the length of time the injector is allowed to stay open during the injection process of the catalyst into the engine air stream. Again, the duration pulse varies based on the size and type of engine. The duration pulse length is controlled by the MCS.

This section consists of a MCS and a data acquisition system. In the preferred embodiment, the MCS consists of a personal computer (PC) connected to a central processing unit (CPU). The CPU is manually programmed, but can also automatically adjust based on instrumentation readings from the diesel engine. The main purpose of the control section 400 is to monitor the engine instrumentations and adjust the flow of the liquid catalyst through the entire system based on input parameters. The control section 400 aids in achieving the highest manufacture efficiency for the particular diesel engine utilizing the high volume combustion catalyst delivery system.

The MCS of the control section 400 is directly connected to the feed section 100, distribution section 200, and injector section 300 as shown in FIG. 4. The CPU and PC monitor all aspects of the modular high volume combustion catalyst delivery system and adjust the flow of the catalyst accordingly. The monitoring parameters are manually input into the CPU and can be changed by the user depending on the readings from the diesel engine gathered by the data acquisition system. In an alternate embodiment, the monitoring parameters can automatically adjust based on the readings of the diesel engine and a pre-loaded algorithm in the CPU.

The MCS monitors the engine and controls the amount of air and liquid catalyst delivered to the injector nozzles 325 and 925. The control system monitors combustion parameters in the engine and adjusts the amount of catalyst and air delivered to maintain optimum results. The system for controlling the catalyst delivery to an internal combustion engine receives a command specifying a desired catalyst to fuel flow rate from an electronic control module. The system generates a feed forward estimate of pulse time interval required to produce the desired flow rate. This estimate is calculated from the actual fuel consumption rate compared to the fuel rate set point. Using a proportional-integral feedback controller, the desired catalyst flow rate is predicted by surface interpolation based on a lookup table, to the actual fuel flow rate. The difference between this actual fuel flow rate and desired flow rate is provided to the feedback controller as an error signal. The feedback controller preferably uses different gain values depending on an operating mode of the engine (speed control and torque control modes).

The preferred embodiment of the invention is described in the Description of Preferred Embodiments. While these descriptions directly describe the one embodiment, it is understood that those skilled in the art may conceive modifications and/or variations to the specific embodiments shown and described herein. Any such modifications or variations that fall within the purview of this description are intended to be included therein as well. Unless specifically noted, it is the intention of the inventor that the words and phrases in the specification and claims be given the ordinary and accustomed meanings to those of ordinary skill in the applicable art(s). The foregoing description of a preferred embodiment and best mode of the invention known to the applicant at the time of filing the application has been presented and is intended for the purposes of illustration and description. It is not intended to be exhaustive or to limit the invention to the precise form disclosed, and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated.

What is claimed is:

1. A high volume combustion catalyst delivery system for use in a diesel engine comprising:
a. a feed section wherein the feed section further comprises:
i. a pump;
ii. a feed tank; and
iii. a feed section outlet;
b. a distribution section wherein the distribution section further comprises:
i. a distribution section inlet coupled to the feed section outlet;
ii. at least one distribution section outlet; and
iii. at least one valve;
c. an injection section wherein the injection section further comprises:
i. at least one injector with an inlet coupled to the distribution section outlet;
d. wherein a liquid catalyst is stored in the feed tank and pumped through the feed section outlet and into the distribution section inlet;
e. wherein the liquid catalyst is pressurized when pumped through the feed section and into the feed section outlet to the distribution section inlet;
f. wherein the pressurized liquid catalyst moves through the at least one valve in the distribution section and passes through the at least one distribution section outlet and into the inlet of the at least one injector;
g. wherein the pressurized liquid catalyst enters the inlet of the injector and is atomized into an aerosol;
h. wherein the at least one injector injects the atomized catalyst aerosol into an air intake stream of the diesel engine.

2. The high volume combustion catalyst delivery system of claim 1 further comprising:
a. a control section wherein the control section further comprises:
i. a programmable microprocessor based controller; and
ii. a data acquisition system;
b. wherein the programmable microprocessor based controller manages the feed, distribution, and injection sections and wherein a controlled amount of atomized catalyst aerosol is delivered to the diesel engine; and
c. wherein the data acquisition system monitors the efficiency and output of the diesel engine.

3. The high volume combustion catalyst delivery system of claim 2 wherein the programmable microprocessor is manually programmed and adjusts based on manually programmed inputs.

4. The high volume combustion catalyst delivery system of claim 1 wherein the at least one injector is a pneumatic injector.

5. The high volume combustion catalyst delivery system of claim 1 wherein the at least one injector is a piezoelectric injector.

6. The high volume combustion catalyst delivery system of claim 1 wherein the feed section, distribution section, and injection section are separate modular components interchangeable within the diesel engine.

7. The high volume combustion catalyst delivery system of claim 1 wherein the feed section further comprises a manual shut off valve wherein a user activates the manual shut off valve to stop flow of the liquid catalyst through the feed section.

8. The high volume combustion catalyst delivery system of claim 1 wherein the feed section further comprises a control valve.

9. The high volume combustion catalyst delivery system of claim 1 wherein the feed section further comprises an operating pressure control regulator.

10. The high volume combustion catalyst delivery system of claim 1 wherein the feed section further comprises a recycle stream wherein unused liquid catalyst is cycled back to the feed tank.

11. The high volume combustion catalyst delivery system of claim 1 wherein the feed section further comprises a leak detector wherein the leak detector detects and activates an alarm when liquid catalyst has leaked out of the feed section.

12. The high volume combustion catalyst delivery system of claim 1 wherein the distribution section further comprises a manual shut off valve wherein a user activates the manual shut off valve to stop flow of the liquid catalyst through the distribution section.

13. The high volume combustion catalyst delivery system of claim 1 wherein the distribution section further comprises an operating pressure control regulator.

14. The high volume combustion catalyst delivery system of claim 1 wherein the distribution section further comprises a leak detector wherein the leak detector detects and activates an alarm when liquid catalyst has leaked out of the delivery system.

15. The high volume combustion catalyst delivery system of claim 1 wherein the distribution section further comprises a pressure relief and system drain wherein the pressure relief and system drain active when the pressure in the system exceeds a set threshold limit.

16. The high volume combustion catalyst delivery system of claim 1 wherein the distribution section is housed in a valve manifold box.

17. The high volume combustion catalyst delivery system of claim 1 wherein the distribution section further comprises a recycle stream wherein unused liquid catalyst is cycled back to the feed tank in the feed section of the delivery system.

18. A high volume combustion catalyst delivery system for use in a diesel engine comprising:
a. a feed section wherein the feed section further comprises:
i. a pump;
ii. a feed tank; and
iii. a feed section outlet;
b. a distribution section wherein the distribution section further comprises:
i. a distribution section inlet coupled to the feed section outlet;
ii. at least one distribution section outlet; and
iii. at least one valve;
c. an injection section wherein the injection section further comprises:
i. at least one injector with an inlet coupled to the distribution section outlet;
d. a control section wherein the control section further comprises:
i. a programmable microprocessor based controller; and
ii. a data acquisition system;
e. wherein a liquid catalyst is stored in the feed tank and pumped through the feed section outlet and into the distribution section inlet;
f. wherein the liquid catalyst is pressurized when moving through the pump and from the feed section outlet to the distribution section inlet;
g. wherein the pressurized liquid catalyst moves through the at least one valve in the distribution section and from the at least one distribution section outlet and into the inlet of the at least one injector;
h. wherein the pressurized liquid catalyst enters the inlet of the injector and is atomized into an aerosol;
i. wherein the atomized catalyst aerosol is injected into an air intake stream of the diesel engine by the at least one injector; and
j. wherein the programmable microprocessor based controller manages the feed, distribution, and injection sections wherein a controlled amount of atomized catalyst aerosol is delivered to the diesel engine and monitors the diesel engine using the data acquisition system.

19. The high volume combustion catalyst delivery system of claim 18 wherein the programmable microprocessor is manually programmed and adjusts based on manually programmed inputs.

20. The high volume combustion catalyst delivery system of claim 18 wherein the programmable microprocessor monitors outputs of the diesel engine.

21. The high volume combustion catalyst delivery system of claim 18 wherein the at least one injector is a pneumatic injector.

22. The high volume combustion catalyst delivery system of claim 18 wherein the at least one injector is a piezoelectric injector.

23. The high volume combustion catalyst delivery system of claim 18 wherein the feed section, distribution section, and injection section are modular components interchangeable within the diesel engine.

24. The high volume combustion catalyst delivery system of claim 18 wherein the feed section further comprises a manual shut off valve wherein a user activates the manual shut off valve to stop flow of the liquid catalyst through the feed section.

25. The high volume combustion catalyst delivery system of claim 18 wherein the feed section further comprises a control valve.

26. The high volume combustion catalyst delivery system of claim 18 wherein the feed section further comprises an operating pressure control regulator.

27. The high volume combustion catalyst delivery system of claim 18 wherein the feed section further comprises a recycle stream wherein the unused liquid catalyst is cycled back to the feed tank.

28. The high volume combustion catalyst delivery system of claim 18 wherein the feed section further comprises a leak detector wherein the leak detector detects and activates an alarm when liquid catalyst has leaked out of the delivery system.

29. The high volume combustion catalyst delivery system of claim 18 wherein the distribution section further comprises a manual shut off valve wherein a user activates the manual shut off valve to stop flow of the liquid catalyst through the distribution section.

30. The high volume combustion catalyst delivery system of claim 18 wherein the distribution section further comprises an operating pressure control regulator.

31. The high volume combustion catalyst delivery system of claim 18 wherein the distribution section further comprises a leak detector wherein the leak detector detects and activates an alarm when liquid catalyst has leaked out of the delivery system.

32. The high volume combustion catalyst delivery system of claim 18 wherein the distribution section further comprises a pressure relief and system drain wherein the pressure relief and system drain active when the pressure in the system exceeds a set threshold limit.

33. The high volume combustion catalyst delivery system of claim 18 wherein the distribution section is housed in a valve manifold box.

34. The high volume combustion catalyst delivery system of claim 18 wherein the distribution section further comprises a recycle stream wherein unused liquid catalyst is cycled back to the feed tank in the feed section.
